(19) United States
(12) Patent Application Publication
(10) Pub. No.: US 2026/0035609 A1
(43) Pub. Date: Feb. 5, 2026

(54) SCALE INHIBITION IN A WELLBORE

(71) Applicant: KING FAHD UNIVERSITY OF PETROLEUM AND MINERALS, Dhahran (SA)

(72) Inventors: Mobeen MURTAZA, Dhahran (SA); Muhammad Shahzad KAMAL, Dhahran (SA); Murtada AL-JAWAD, Dhahran (SA); Shabeeb Nasser ALAJMEI, Dhahran (SA); Ose BUDIMAN, Dhahran (SA); Mohamed MAHMOUD, Dhahran (SA)

(73) Assignee: KING FAHD UNIVERSITY OF PETROLEUM AND MINERALS, Dhahran (SA)

(21) Appl. No.: 19/075,283

(22) Filed: Mar. 10, 2025

Related U.S. Application Data
(60) Provisional application No. 63/678,998, filed on Aug. 2, 2024.

(51) Int. Cl. C09K 8/532

(52) U.S. Cl. CPC C09K 8/532

(57) ABSTRACT

A method of inhibiting sulfate-including scale formation in a high-pressure high-temperature (HPHT) wellbore includes injecting a chemical scale inhibitor into a wellbore disposed in a subterranean geological formation, contacting the chemical scale inhibitor with a wall of the wellbore to delay an onset of sulfate scale formation on the wall of the wellbore. The chemical scale inhibitor is an aqueous solution includes at least 0.15 w/v % of 1-butyl-2,3-dimethylimidazolium hexafluorophosphate relative to a total volume of the aqueous solution.

### CROSS-REFERENCE TO RELATED APPLICATION

The present application claims benefit of priority to U.S. Provisional Application No. 63/678,998 having a filing date of Aug. 2, 2024 which is incorporated here by reference in its entirety.

### BACKGROUND

### Technical Field

The present disclosure is directed towards scale inhibition techniques, and more particularly, towards a method of inhibiting scale formation utilizing an aqueous scale-inhibitor, in a wellbore.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

In the oil and gas industry, scale refers to the undesirable precipitation and accumulation of solids inside wellbores, pipelines, and production equipment. Scale formation is a major problem in the oil and gas industry because it may cause lower efficiency, increase maintenance costs, and increase the prevalence equipment malfunction due to the decreased flow capability of the wellbore. Scale formations may include mineral deposits such as calcium carbonate, calcium sulfate, and barium sulfate that form within pipes, valves, and processing equipment. Scaling can may in various locations, including inside the reservoir, near the wellbore area, within production tubulars, in topside facilities, and in wells used for re-injecting produced water.

Removing scale formation is challenging due to its acid resistance. Conventionally, scale formation may be removed by use of chemical solutions, such as calcium hydroxide. Conventional chemical solutions for scale removal, however, may lead to sludge accumulation, necessitating an acid wash after use, which may lead to equipment damage and exposure to toxic chemicals for drill workers. Temperature and pressure may also significantly affect the effectiveness of chemical scale inhibitors, with higher temperatures often leading to decreased inhibitor performance and high pressure sometimes impacting stability, meaning the inhibitor may degrade or become less effective under extreme conditions. Thus, there is a need for an effective chemical scale inhibitor that does not need a subsequent acid wash to remove remaining scale formations, and which is able to perform well in high pressure and high temperature drilling environments.

Accordingly, one object of the present disclosure is to provide an aqueous chemical scale-inhibitor for scale inhibition in a high-pressure high-temperature (HPHT) wellbore.

### SUMMARY

In an exemplary embodiment, a method of inhibiting sulfate-comprising scale formation in a high-pressure high-temperature (HPHT) wellbore is disclosed. The method comprises injecting a chemical scale inhibitor into a wellbore disposed in a subterranean geological formation, contacting the chemical scale inhibitor with a wall of the wellbore to delay an onset of sulfate-comprising scale formation on the wall of the wellbore. The chemical scale inhibitor is an aqueous solution comprising at least 0.15 w/v % of 1-butyl-2,3-dimethylimidazolium hexafluorophosphate relative to a total volume of the aqueous solution, and the onset of sulfate-comprising scale formation is delayed by at least 24 hours. The wall of the wellbore contacted with the chemical scale inhibitor is at a temperature of at least 150° F.

In some embodiments, the sulfate-comprising scale includes at least one selected from the group consisting of calcium sulfate, magnesium sulfate, iron sulfate, and barium sulfate.

In some embodiments, the aqueous solution comprises at least 0.5 w/v % of the 1-butyl-2,3-dimethylimidazolium hexafluorophosphate.

In some embodiments, no sulfate-comprising scale precipitate is formed in an aqueous composition comprising 0.1 grams per liter (g/L) to 0.5 g/L NaHCO₃, 0.5 g/L to 6 g/L Na₂SO₄, 40 g/L to 150 g/L NaCl, 2 g/L to 70 g/L CaCl₂·2H₂O, 17 g/L to 20 g/L MgCl₂·6H₂O, and 0.35 w/v % to 1 w/v % of the 1-butyl-2,3-dimethylimidazolium hexafluorophosphate at a temperature of from 150° F. to 320° F.

In some embodiments, the contacting is performed for at least 1 hour.

In some embodiments, the chemical scale inhibitor has a pH of 6 to 9 at an initiation of the contacting.

In some embodiments, the sulfate-comprising scale comprises barium sulfate.

In some embodiments, the chemical scale inhibitor is an aqueous solution comprising at least 0.35 w/v % of the 1-butyl-2,3-dimethylimidazolium hexafluorophosphate relative to a total volume of the aqueous solution.

In some embodiments, the chemical scale inhibitor has a pH of 1 to 6 at a termination of the contacting.

In some embodiments, no sulfate-comprising scale precipitate is formed in an aqueous composition comprising 0.1 to 0.5 g/L NaHCO₃, 0.5 g/L to 6 g/L Na₂SO₄, 40 g/L to 151 g/L NaCl, 2 g/L to 70 g/L CaCl₂·2H₂O, 17 g/L to 21 g/L MgCl₂·6H₂O, and 0.9 w/v % to 1 w/v % of the 1-butyl-2,3-dimethylimidazolium hexafluorophosphate at a temperature of 150° F.

In some embodiments, the chemical scale inhibitor further comprises at least one additive selected from the group consisting of an ammonium salt, a cross-linking agent, a proppant, an oxygen scavenger, a corrosion inhibitor, a fluid-loss additive, a friction reducer, a chelating agent, a dispersant, a wetting agent, a scale disperser, a pH stabilizer, a de-emulsifier, a hydrate inhibitor, a clay stabilizer, an anti-foaming agent, a viscosifier, a fluid stabilizer, a thermal stabilizer, a flow enhancer, a scale dissolver, a fouling inhibitor, a defoamer, a crystallization inhibitor, and a scale modifier.

In some embodiments, the wall of the wellbore contacted with the chemical scale inhibitor is at a temperature of 150° F. to 320° F.

In some embodiments, the sulfate-comprising scale comprises calcium sulfate.

In some embodiments, the contacting is performed for at least 24 hours.

In some embodiments, the chemical scale inhibitor further comprises a brine comprising at least one of a synthetic seawater, a formation water, or a combination thereof. The synthetic seawater comprises 0.1 g/L to 0.2 g/L NaHCO₃, 6 g/L to 7 g/L Na₂SO₄, 41 g/L to 42 g/L NaCl, 2 g/L to 3 g/L CaCl₂·2H₂O, and 17 g/L to 18 g/L MgCl₂·6H₂O, and the formation water comprises 0.4 g/L to 0.5 g/L NaHCO₃, 0.5 g/L to 0.6 g/L Na₂SO₄, 150 g/L to 151 g/L NaCl, 69 g/L to 70 g/L CaCl₂·2H₂O, and 20 g/L to 21 g/L MgCl₂·6H₂O.

In some embodiments, the chemical scale inhibitor further comprises a brine comprising a synthetic seawater and a formation water, and the brine has a weight ratio of the synthetic seawater to the formation water of 1:3 to 3:1.

In some embodiments, the chemical scale inhibitor has a density of 1.10 g/cm³ to 1.50 g/cm³ at a temperature of 20° C.

In some embodiments, the chemical scale inhibitor has a viscosity of 10 cP to 100 cP.

In some embodiments, no sulfate-comprising scale precipitate is formed in an aqueous composition comprising 0.1 g/L to 0.5 g/L NaHCO₃, 0.5 g/L to 6 g/L Na₂SO₄, 40 g/L to 151 g/L NaCl, 2 g/L to 70 g/L CaCl₂·2H₂O, 17 g/L to 21 g/L MgCl₂·6H₂O, and 0.5 w/v % to 0.75 w/v % of 1-butyl-2,3-dimethylimidazolium hexafluorophosphate at a temperature of 320° F.

In some embodiments, the chemical scale inhibitor has a density of 1.30 g/cm³ to 1.50 g/cm³ at a temperature of 20° C.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a schematic flow chart of a method of inhibiting sulfate-comprising scale formation in a high-pressure high-temperature (HPHT) wellbore, according to certain embodiments.

FIG. 2A is an optical image of a plurality of test tubes comprising sea water (SW) and formation water (FW) with different concentrations of chemical scale inhibitor, at the commencement of evaluations, according to certain embodiments.

FIG. 2B is an optical image of the plurality of test tubes comprising SW and FW with different concentrations of chemical scale inhibitor after 24 hours and at a temperature of about 150° F., according to certain embodiments.

FIG. 2C is an optical image of the plurality of test tube comprising SW and FW with different concentrations of chemical scale inhibitor after 48 hours and at a temperature of about 150° F., according to certain embodiments.

FIG. 2D is an optical image of the plurality of test tubes comprising SW and FW with different concentrations of chemical scale inhibitor after 120 hours and at a temperature of about 150° F., according to certain embodiments.

FIG. 2E is an optical image of the plurality of test tube comprising SW and FW with different concentrations of chemical scale inhibitor after 168 hours and at a temperature of about 150° F., according to certain embodiments.

### DETAILED DESCRIPTION

In the drawings, like reference numerals designate identical or corresponding parts throughout the several views. Further, as used herein, the words “a”, “an” and the like generally carry a meaning of “one or more”, unless stated otherwise.

Furthermore, the terms “approximately,” “approximate”, “about” and similar terms generally refer to ranges that include the identified value within a margin of 20%, 10%, or preferably 5%, and any values therebetween.

As used herein, the term “wellbore” refers to the hole or shaft drilled into the earth's surface to access underground formations, such as oil, gas, or water reservoirs. It is typically created through drilling operations and can vary in depth and diameter depending on the target formation and the specific requirements of the drilling process. The wellbore serves as the conduit for the extraction of fluids or gases, and can also be used for injecting fluids, including chemicals like scale inhibitors, for reservoir management or enhanced recovery processes.

As used herein, the term “chemical scale inhibitor” refers to a substance or formulation that is used to prevent or reduce the formation and deposition of scale, such as mineral salts, in oil and gas wells, pipelines, and production equipment. These inhibitors interfere with the crystal growth of scale-forming minerals, preventing them from adhering to surfaces and causing blockages or damage. Chemical scale inhibitors may be in the form of organic or inorganic compounds, such as surfactants, chelating agents, or polymers.

As used herein, the term “subterranean geological formation” refers to a naturally occurring layer or stratum of rock, sediment, or soil located beneath the earth's surface. These formations often contain natural resources such as oil, gas, minerals, or groundwater. Subterranean geological formations are typically accessed through wellbores drilled into the earth for exploration or extraction purposes.

As used herein, the term “sulfate-comprising scale formation” refers to the accumulation and deposition of scale primarily composed of sulfate minerals, such as barium sulfate (BaSO₄), calcium sulfate (CaSO₄), or strontium sulfate (SrSO₄), in oil and gas production systems. These scales may form when incompatible fluids, rich in sulfate ions, mix with fluids comprising calcium, barium, or strontium ions, leading to the precipitation of sulfate compounds. Sulfate-comprising scale formation can obstruct pipelines, production equipment, and wellbores, reducing operational efficiency and increasing maintenance costs.

Aspects of this disclosure are directed to a method of inhibiting sulfate-comprising scale formation in a high-pressure high-temperature (HPHT) wellbore. Inhibiting sulfate-comprising scale formation in HPHT wellbores aids in maintaining optimal fluid flow while drilling, preventing equipment damage, and reducing downtime and maintenance costs.

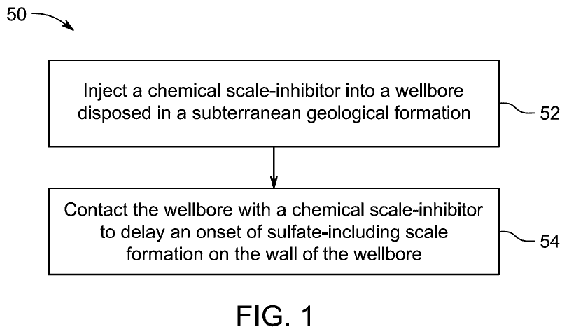

A method of inhibiting sulfate-comprising scale formation in a high-pressure high-temperature (HPHT) wellbore is described. FIG. 1 illustrates a schematic flow chart of a method 50 of inhibiting sulfate-comprising scale formation in a HPHT wellbore. The order in which the method 50 is described is not intended to be construed as a limitation, and any number of the described method steps can be combined to implement the method 50. Additionally, individual steps may be removed or skipped from the method 50 without departing from the spirit and scope of the present disclosure.

At step 52, the method 50 comprises injecting a chemical scale inhibitor into a wellbore disposed in a subterranean geological formation. In some embodiments, the chemical scale inhibitor is an aqueous solution comprising at least 0.15 w/v % of 1-butyl-2,3-dimethylimidazolium hexafluorophosphate relative to a total volume of the aqueous solution. 1-butyl-2,3-dimethylimidazolium hexafluorophosphate has a chemical structure of Formula (I)

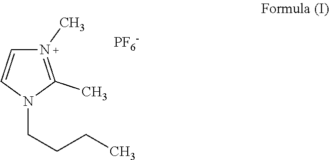

In another embodiment, the chemical scale inhibitor is an aqueous solution comprising at least 0.20 w/v % of 1-butyl-2,3-dimethylimidazolium hexafluorophosphate, preferably at least 0.25 w/v %, preferably at least 0.30 w/v %, preferably at least 0.35 w/v %, preferably at least 0.40 w/v %, preferably at least 0.45 w/v %, preferably at least 0.50 w/v %, preferably at least 0.55 w/v %, preferably at least 0.60 w/v %, preferably at least 0.65 w/v5, preferably at least 0.70 w/v %, preferably at least 0.75 w/v %, preferably at least 0.80 w/v %, preferably at least 0.85 w/v %, preferably at least 0.90 w/v %, preferably at least 0.95 w/v %, preferably at least 1 w/v % of 1-butyl-2,3-dimethylimidazolium hexafluorophosphate. In a preferred embodiment, the chemical scale inhibitor is an aqueous solution comprising 0.15 w/v % to 1 w/v % of the 1-butyl-2,3-dimethylimidazolium hexafluorophosphate relative to a total volume of the aqueous solution.

In an embodiment of the invention, the 1-butyl-2,3-dimethylimidazolium hexafluorophosphate is injected into a wellbore as a mixture with particles of a wax. The wax particles preferably have a particle size of from 0.5 to 100 μm or 10 to 50 μm. The wax preferably has a high melting point such as a Carnauba wax. More preferably, the wax is a synthetic wax such as a polypropylene wax having a melting point of 150 to 160° C. Preferably the 1-butyl-2,3-dimethylimidazolium hexafluorophosphate is injected into the wellbore as a solution in water, for example, from 0.1 to 10 wt. % or 0.5 to 5 wt. % based on the total weight of the composition injected into the wellbore. The mixture of water, 1-butyl-2,3-dimethylimidazolium hexafluorophosphate and high melting synthetic wax forms a suspension that effectively segregates hydrocarbon materials from the ionic liquid at the point the chemical scale inhibitor composition is contacted with the wellbore wall.

In some embodiments, the chemical scale inhibitor further comprises at least one additive selected from the group consisting of an ammonium salt, a cross-linking agent, a proppant, an oxygen scavenger, a corrosion inhibitor, a fluid-loss additive, a friction reducer, a chelating agent, a dispersant, a wetting agent, a scale disperser, a pH stabilizer, a de-emulsifier, a hydrate inhibitor, a clay stabilizer, an anti-foaming agent, a viscosifier, a fluid stabilizer, a thermal stabilizer, a flow enhancer, a scale dissolver, a fouling inhibitor, a defoamer, a crystallization inhibitor, and a scale modifier. Ammonium salts, such as quaternary ammonium salts, may be added to chemical scale inhibitors due to their ability to effectively adsorb onto mineral surfaces, disrupting crystal growth and preventing scale formation. Ammonium salts may function across a wide pH range and often require only small concentrations to achieve scale inhibition. Suitable ammonium salts include, but are not limited to, 2-acrylamido-2-methyl propane sulfonic acid (AMPS), alkyltrimethyl ammonium chloride, aminotrimethylene phosphonic acid (ATMP), and ethylenediaminetetramethylene phosphonic acid (EDTMP). Cross-linking agents may be added to chemical scale inhibitors to increase the viscosity and stability of the chemical scale inhibitor, allowing for better suspension and transport of drill cuttings, improved fluid loss control, enhanced wellbore stability, and better performance in high-temperature and high-pressure environments. Suitable cross-linking agents include, but are not limited to, borates (e.g., sodium borate), zirconium compounds (e.g., zirconium oxychloride), transition metals, and certain polymers like guar gum. Proppants may be added to chemical scale inhibitors to reduce the required amount of chemical scale inhibitors to be used within the wellbore and to extend their length of effectiveness within the wellbore. Suitable proppants include, but are not limited to, silica sand, resin-coated sand, and ceramic sand. Oxygen scavengers may be added to chemical scale inhibitors to react with and remove dissolved oxygen from the drilling system, preventing corrosion. Suitable oxygen scavengers include, but are not limited to, sodium sulfite, sodium bisulfite, sodium metabisulfite, ammonium bisulfite, diethylhydroxylamine (DEHA), and carbohydrazide. Corrosion inhibitors may be added to chemical scale inhibitors to protect surfaces from corrosion within a drilling system, which aids in extending equipment lifespan, reducing maintenance costs, improving operational efficiency, and improving reliability by preventing the build-up of corrosive damage. Suitable corrosion inhibitors include, but are not limited to, phosphates (like orthophosphate), silicates, molybdates, chromates, azoles (benzotriazole, triazole), polyacrylates, and various organic amines. Fluid-loss additives may be added to a chemical scale inhibitor may aid in preventing the chemical scale inhibitor from leaking into the subterranean geological formation, enabling the chemical scale inhibitor to be concentrated where it's needed to effectively inhibit scale formation, thereby maximizing the efficiency of the scale inhibitor and minimizing potential damage to the reservoir rock by maintaining a stable fluid volume within the wellbore. Suitable fluid-loss additives include, but are not limited to, polymeric compounds like carboxymethyl cellulose (CMC), lignosulfonates, modified starches, and high molecular weight polyacrylamides Friction reducers may be added to chemical scale inhibitors to aid delivery of the chemical scale inhibitor to the desired location within a wellbore by reducing friction within the pipe, enabling higher flow rates at lower pumping pressures, thus maximizing the effectiveness of the chemical scale inhibitor treatment and minimizing potential pressure losses during application. Suitable friction reducers include, but are not limited to, polyacrylamide-(PAM-) based polymers, acrylic acids, and acrylamido-methyl-propane sulfonate polymer (AMPS) copolymers. Chelating agents may be added to chemical scale inhibitors to aid in preventing the formation of scales by binding with metal ions in water, sequestering them, and stopping them from participating in the precipitation process that creates scale deposits. Suitable chelating agents include, but are not limited to, ethylenediaminetetraacetic acid (EDTA), diethylenetriaminepentaacetic acid (DTPA), nitrilotriacetic acid (NTA), etidronic acid (HEDP), and various phosphonates. Dispersants may be added to chemical scale inhibitors to prevent newly formed scale particles from clumping together and settling out which helps to maintain system efficiency by preventing blockages and improving flow. Suitable dispersants include, but are not limited to, polyphosphates (e.g., sodium hexametaphosphate), organic phosphonates (e.g., 1-hydroxyethylidene-1,1-diphosphonic acid (HEDP) and aminotrimethylene phosphonic acid (ATMP)), polyacrylic acid (PAA), polymaleic acid, lignosulfonates, acrylate-based polymers, and certain types of cellulose derivatives (e.g., carboxymethyl cellulose). Wetting agents may be added to chemical scale inhibitors to reduce surface tension, enabling the chemical scale inhibitor to better encapsulate and lift the scale precipitates from the wellbore, preventing them from sticking to the formation and ensuring efficient removal to the surface. Suitable examples of wetting agents used in chemical scale inhibitors include, but are not limited to, sodium lauryl sulfate (SLS), polysorbate 80, alkylphenol ethoxylates, poloxamers, and modified starches. Scale dispersers may be added to chemical scale inhibitor to prevent newly formed scale crystals from settling and accumulating on surfaces. Suitable scale dispersers include, but are not limited to, polyacrylates, polymethacrylates, acrylate-based polymers, sulfonated copolymers, and low molecular weight anionic polymers. Chemical scale inhibitors may also comprise pH stabilizers which aid in maintaining a consistent pH level, preventing potential degradation or reduced efficacy of the chemical scale inhibitor due to pH variations. Suitable pH stabilizers include, but are not limited to, polyphosphates, organic phosphonates, polyacrylates, and certain amino acids. De-emulsifers may be added to chemical scale inhibitors to prevent the formation of emulsions, which can hinder the effectiveness of the scale inhibitor by encapsulating scale-forming ions and impeding their access to the inhibitor. Suitable de-emulsifiers include, but are not limited to, polymeric compounds like poly(ethylene oxide) (PEO) and polyacrylamide (PAM). Hydrate inhibitors, when added to chemical scale inhibitors, aid in the prevention of gas hydrate formations in pipelines and production equipment, thereby allowing for increased producing efficiency. Suitable hydrate inhibitors include, but are not limited to, methanol (MeOH), monoethylene glycol (MEG), and diethylene glycol (DEG). Clay stabilizers added to a chemical scale inhibitor may help prevent issues related to clay swelling and dispersion in formations, ensuring the scale inhibitor can effectively reach and target the desired areas for scale prevention. Suitable clay stabilizers may include, but are not limited to, quaternary ammonium compounds (e.g., tetramethylammonium chloride), cationic polymers, choline chloride, potassium chloride, and hydrolyzable metal ions (e.g., zirconium oxychloride). In chemical scale inhibitors, anti-foaming agents may aid in preventing excessive foam formation which can disrupt the scale inhibition process, leading to improved efficiency. Suitable anti-foaming agents include silicones (like polydimethylsiloxane), mineral oils, fatty alcohols, hydrophobic silica, and certain types of long-chain alcohols. In chemical scale inhibitors, viscosifiers may increase the chemical scale inhibitor's viscosity, which helps the inhibitor to better adhere to surfaces, ensuring more even distribution and longer contact time with potential scaling areas, leading to improved scale inhibition efficacy. Examples of viscosifiers include bentonite clay, xanthan gum, guar gum, polyanionic cellulose (PAC), attapulgite clay, carboxymethyl cellulose (CMC), starches (e.g., corn starch or potato starch), and sepiolite clay. Fluid stabilizers in a chemical scale inhibitor may help maintain the consistency and effectiveness of the inhibitor by preventing its components from separating or precipitating out of the solution. Suitable fluid stabilizers include, but are not limited to, polymeric compounds like polyacrylates, sulfonated polymers, and copolymers containing both phosphonate and sulfonate moieties. Thermal stabilizers may be added to chemical scale inhibitors to aid in maintaining the inhibitor's desired properties, particularly viscosity and filtration control, even at high temperatures encountered during deep drilling operations, preventing degradation of the inhibitor. Examples of thermal stabilizers include synthetic polymers like 2-acrylamido-2-methylpropane sulfonic acid (AMPS) copolymers, silica nanoparticles, modified natural polymers like lignin or humic acid, and certain types of clays with high thermal stability. Flow enhancers added to chemical scale inhibitors may improve the inhibitor's ability to circulate efficiently within the wellbore, leading to reduced torque and drag, better scale removal, and overall enhanced efficiency. Examples of flow enhancers include polymeric additives such as sulfonated polyacrylic acid (SPAA), polyacrylamide (PAM), and copolymers with functional groups like carboxylate and sulfonate. Chemical scale inhibitors may also contain scale dissolvers, which aid in removing existing mineral scale deposits in addition to preventing new scale formation. Suitable scale dissolvers include, but are not limited to, hydrochloric acid (HCl), organic acids like acetic acid and formic acid, chelating agents like ethylenediaminetetraacetic acid (EDTA) and diethylenetriaminepentaacetic acid (DTPA), acrylic acid, and polyphosphonates like ATMP and polyphosphonocarboxylic acid (PPCA). Fouling inhibitors, when added to chemical scale inhibitors, may aid in preventing the buildup of deposits and fouling on surfaces within a drilling system. Examples of fouling inhibitors include polyphosphates (e.g., sodium hexametaphosphate), organophosphonates (e.g., HEDP), PAA, 2-phosphonobutane-1,2,4-tricarboxylic acid (PBTC), and diethylenetriamine penta(methylene phosphonic acid) (DTPMP). In chemical scale inhibitors, a defoamer may be added to prevent excessive foam formation, which can hinder the effectiveness of the scale inhibitor by disrupting its distribution and preventing proper contact with the surfaces where scaling occurs. Examples of defoamers may include silicone-based compounds, octyl alcohol, aluminum stearate, various glycols, sulfonated hydrocarbons, and certain types of fatty alcohols. Crystallization inhibitors may be added to chemical scale inhibitors to help prevent the formation of mineral scale deposits on surfaces by interfering with the crystal growth process, minimizing the buildup of deposits on equipment surfaces. Suitable examples of crystallization inhibitors include, but are not limited to, polyphosphates, phosphonates, polyacrylic acid (PAA), carboxylates, sulfonates, diethylenetriaminepenta(methylene phosphonic acid) (DETPMP), and polyaspartic acid (PASP). Scale modifiers in chemical scale inhibitors may aid in preventing scale formation by altering the crystal structure of the scale, reducing the likelihood of large scale deposits. Examples of scale modifiers include PAA, phosphonates (e.g., HEDP or DTPMP), polycarboxylates, ATMP, EDTA, and sulfonated polymers.

In some embodiments, the chemical scale inhibitor further comprises a brine comprising at least one of a synthetic seawater, a formation water, or a combination thereof. In a preferred embodiment, the chemical scale inhibitor further comprises a brine comprising a synthetic seawater and a formation water. In some embodiments, the synthetic seawater comprises 0.1 to 0.2 g/L of NaHCO₃. In another embodiment, the synthetic seawater comprises 0.105 to 0.195 g/L NaHCO₃, preferably 0.110 to 0.190 g/L, preferably 0.115 to 0.185 g/L, preferably 0.120 to 0.180 g/L, preferably 0.125 to 0.175 g/L, preferably 0.130 to 0.170 g/L, preferably 0.135 to 0.165 g/L, preferably 0.140 to 0.165 g/L, preferably 0.145 to 0.165 g/L, preferably 0.150 to 0.165 g/L, preferably 0.155 to 0.165 g/L, preferably 0.160 to 0.165 g/L, most preferably 0.165 g/L NaHCO₃. In some embodiments, the synthetic seawater comprises 6 to 7 g/L of Na₂SO₄. In another embodiment, the synthetic seawater comprises 6.05 to 6.95 g/L, preferably 6.10 to 6.90 g/L, preferably 6.15 to 6.85 g/L, preferably 6.20 to 6.80 g/L, preferably 6.25 to 6.75 g/L, preferably 6.30 to 6.70 g/L, preferably 6.30 to 6.65 g/L, preferably 6.30 to 6.60 g/L, preferably 6.30 to 6.55 g/L, preferably 6.30 to 6.50 g/L, preferably 6.30 to 6.45 g/L, preferably 6.30 to 6.40 g/L, preferably 6.30 to 6.35 g/L most preferably 6.339 g/L Na₂SO₄. In some embodiments, the synthetic seawater comprises 41 to 42 g/L NaCl. In another embodiment, the synthetic seawater comprises 41.05 to 41.95 g/L NaCl, preferably 41.10 to 41.90 g/L, preferably 41.15 to 41.85 g/L, preferably 41.15 to 41.80 g/L, preferably 41.15 to 41.75 g/L, preferably 41.15 to 41.70 g/L, preferably 41.15 to 41.65 g/L, preferably 41.15 to 41.60 g/L, preferably 41.15 to 41.55 g/L, preferably 41.15 to 41.50 g/L, preferably 41.15 to 41.45 g/L, preferably 41.15 to 41.40 g/L, preferably 41.15 to 41.35 g/L, preferably 41.15 to 41.30 g/L, preferably 41.15 to 41.25 g/L, preferably 41.15 to 41.20 g/L, most preferably 41.172 g/L NaCl. In some embodiments, the synthetic seawater comprises 2 to 3 g/L CaCl₂·2H₂O. In another embodiment, the synthetic seawater comprises 2.05 to 2.95 g/L CaCl₂·2H₂O, preferably 2.10 to 2.90 g/L, preferably 2.15 to 2.85 g/L, preferably 2.20 to 2.85 g/L, preferably 2.25 to 2.85 g/L, preferably 2.30 to 2.85 g/L, preferably 2.35 to 2.85 g/L, preferably 2.40 to 2.85 g/L, preferably 2.45 to 2.85 g/L, preferably 2.50 to 2.85 g/L, preferably 2.55 to 2.85 g/L, preferably 2.60 to 2.85 g/L, preferably 2.65 to 2.85 g/L, preferably 2.70 to 2.85 g/L, preferably 2.75 to 2.85 g/L, preferably 2.80 to 2.85 g/L, most preferably 2.837 g/L CaCl₂·2H₂O. In some embodiments, the synthetic seawater comprises 17 to 18 g/L MgCl₂·6H₂O. In another embodiment, the synthetic seawater comprises 17.05 to 17.95 g/L MgCl₂·6H₂O, preferably 17.10 to 17.90 g/L, preferably 17.15 to 17.85 g/L, preferably 17.20 to 17.80 g/L, preferably 17.25 to 17.75 g/L, preferably 17.30 to 17.70 g/L, preferably 17.35 to 17.65 g/L, preferably 17.40 to 17.65 g/L, preferably 17.45 to 17.65 g/L, preferably 17.50 to 17.65 g/L, preferably 17.55 to 17.65 g/L, preferably 17.60 to 17.65 g/L, most preferably 17.644 g/L MgCl₂·6H₂O.

In some embodiments, the formation water comprises 0.4 to 0.5 g/L of NaHCO₃. In another embodiment, the formation water comprises 0.405 to 0.495 g/L NaHCO₃, preferably 0.410 to 0.490 g/L, preferably 0.415 to 0.490 g/L, preferably 0.420 to 0.490 g/L, preferably 0.425 to 0.490 g/L, preferably 0.430 to 0.490 g/L, preferably 0.435 to 0.490 g/L, preferably 0.440 to 0.490 g/L, preferably 0.445 to 0.490 g/L, preferably 0.450 to 0.490 g/L, preferably 0.455 to 0.490 g/L, preferably 0.460 to 0.490 g/L, preferably 0.465 to 0.490 g/L, preferably 0.470 to 0.490 g/L, preferably 0.475 to 0.490 g/L, preferably 0.480 to 0.490 g/L, preferably 0.485 to 0.490 g/L, most preferably 0.487 g/L NaHCO₃. In some embodiments, the formation water comprises 0.5 to 0.6 g/L of Na₂SO₄. In another embodiment, the formation water comprises 0.505 to 0.595 g/L Na₂SO₄, preferably 0.510 to 0.590 g/L, preferably 0.515 to 0.585 g/L, preferably 0.515 to 0.580 g/L, preferably 0.515 to 0.575 g/L, preferably 0.515 to 0.570 g/L, preferably 0.515 to 0.565 g/L, preferably 0.515 to 0.560 g/L, preferably 0.515 to 0.555 g/L, preferably 0.515 to 0.550 g/L, preferably 0.515 to 0.545 g/L, preferably 0.515 to 0.540 g/L, preferably 0.515 to 0.535 g/L, preferably 0.515 to 0.530 g/L, preferably 0.515 to 0.525 g/L, preferably 0.515 to 0.520 g/L, most preferably 0.518 g/L Na₂SO₄. In some embodiments, the formation water comprises 150 to 151 g/L NaCl. In another embodiment, the formation water comprises 150.05 to 150.95 g/L NaCl, preferably 150.05 to 150.95 g/L, preferably 150.10 to 150.90 g/L, preferably 150.15 to 150.85 g/L, preferably 150.20 to 150.80 g/L, preferably 150.25 to 150.75 g/L, preferably 150.30 to 150.70 g/L, preferably 150.35 to 150.65 g/L, preferably 150.40 to 150.60 g/L, preferably 150.40 to 150.55 g/L, preferably 150.40 to 150.50 g/L, preferably 150.40 to 150.45 g/L, most preferably 150.446 g/L NaCl. In some embodiments, the formation water comprises 69 to 70 g/L CaCl₂·2H₂O. In another embodiment, the formation water comprises 69.05 to 69.95 g/L CaCl₂·2H₂O, preferably 69.10 to 69.90 g/L, preferably 69.15 to 69.85 g/L, preferably 69.20 to 69.85 g/L, preferably 69.25 to 69.85 g/L, preferably 69.30 to 69.85 g/L, preferably 69.35 to 69.85 g/L, preferably 69.40 to 69.85 g/L, preferably 69.45 to 69.85 g/L, preferably 69.50 to 69.85 g/L, preferably 69.55 to 69.85 g/L, preferably 69.60 to 69.85 g/L, preferably 69.65 to 69.85 g/L, preferably 69.70 to 69.85 g/L, preferably 69.75 to 69.85 g/L, preferably 69.80 to 69.85 g/L, most preferably 69.841 g/L CaCl₂·2H₂O. In some embodiments, the formation water comprises 20 to 21 g/L MgCl₂·6H₂O. In another embodiment, the formation water comprises 20.05 to 20.95 g/L MgCl₂·6H₂O, preferably 20.10 to 20.90 g/L, preferably 20.15 to 20.85 g/L, preferably 20.20 to 20.80 g/L, preferably 20.25 to 20.75 g/L, preferably 20.30 to 20.70 g/L, preferably 20.35 to 20.65 g/L, preferably 20.35 to 20.60 g/L, preferably 20.35 to 20.55 g/L, preferably 20.35 to 20.50 g/L, preferably 20.35 to 20.45 g/L, preferably 20.35 to 20.40 g/L, most preferably 20.396 g/L MgCl₂·6H₂O.

In some embodiments, the brine has a weight ratio of the synthetic seawater to the formation water of 1:3 to 3:1, preferably 1:2.8 to 2.8:1, preferably 1:2.6 to 2.6:1, preferably 1:2.4 to 2.4:1, preferably 1:2.2 to 2.2:1, preferably 1:2 to 2:1, preferably 1:1.8 to 1.8:1, preferably 1:1.6 to 1.6:1, preferably 1:1.4 to 1.4:1, preferably 1:1.2 to 1.2:1, most preferably 1:1 of the synthetic seawater to the formation water.

In some embodiments, the chemical scale inhibitor has a density of 1 to 2 g/cm³ at a temperature of 20° C. In another embodiment, the chemical scale inhibitor has a density of 1.05 to 1.95 g/cm³ at a temperature of 20° C., preferably 1.10 to 1.90 g/cm³, preferably 1.15 to 1.85 g/cm³, preferably 1.20 to 1.80 g/cm³, preferably 1.25 to 1.75 g/cm³, preferably 1.30 to 1.70 g/cm³, preferably 1.30 to 1.65 g/cm³, preferably 1.30 to 1.60 g/cm³, preferably 1.30 to 1.55 g/cm³, preferably 1.30 to 1.50 g/cm³, preferably 1.30 to 1.45 g/cm³, preferably 1.30 to 1.40 g/cm³, preferably 1.30 to 1.35 g/cm³. In a preferred embodiment, the chemical scale inhibitor has a density of 1.345 g/cm³ at a temperature of 20° C.

In some embodiments, the chemical scale inhibitor has a viscosity of 1 to 250 cP. In another embodiment, the chemical scale inhibitor has a viscosity of 5 to 245 cP, preferably 10 to 240 cP, preferably 10 to 235 cP, preferably 10 to 230 cP, preferably 10 to 225 cP, preferably 10 to 220 cP, preferably 10 to 215 cP, preferably 10 to 210 cP, preferably 10 to 205 cP, preferably 10 to 200 cP, preferably 10 to 195 cP, preferably 10 to 190 cP, preferably 10 to 185 cP, preferably 10 to 180 cP, preferably 10 to 175 cP, preferably 10 to 170 cP, preferably 10 to 165 cP, preferably 10 to 160 cP, preferably 10 to 155 cP, preferably 10 to 150 cP, preferably 10 to 145 cP, preferably 10 to 140 cP, preferably 10 to 135 cP, preferably 10 to 130 cP, preferably 10 to 125 cP, preferably 10 to 120 cP, preferably 10 to 115 cP, preferably 10 to 110 cP, preferably 10 to 105 cP, preferably 10 to 100 cP, preferably 10 to 95 cP, preferably 10 to 90 cP, preferably 10 to 85 cP, preferably 10 to 80 cP, preferably 10 to 75 cP, preferably 10 to 70 cP, preferably 10 to 65 cP, preferably 10 to 60 cP, preferably 10 to 55 cP, preferably 10 to 50 cP, preferably 10 to 45 cP, preferably 10 to 40 cP, preferably 10 to 35 cP, preferably 10 to 30 cP, most preferably 10 to 25 cP.

In some embodiments, the chemical scale inhibitor has a molecular weight of 200 to 500 g/mol. In another embodiment, the chemical scale inhibitor has a molecular weight of 210 to 490 g/mol, preferably 220 to 480 g/mol, preferably 230 to 470 g/mol, preferably 240 to 460 g/mol, preferably 240 to 460 g/mol, preferably 250 to 450 g/mol, preferably 260 to 440 g/mol, preferably 270 to 430 g/mol, preferably 280 to 420 g/mol, preferably 290 to 410 g/mol, preferably 300 to 410 g/mol, preferably 310 to 410 g/mol, preferably 320 to 410 g/mol, preferably 330 to 410 g/mol, preferably 340 to 410 g/mol, preferably 350 to 410 g/mol, preferably 360 to 410 g/mol, preferably 370 to 410 g/mol, preferably 380 to 410 g/mol, preferably 390 to 410 g/mol, preferably 400 to 410 g/mol, most preferably about 405.625 g/mol.

At step 54, the method 50 comprises contacting the chemical scale inhibitor with a wall of the wellbore to delay an onset of sulfate-comprising scale formation on the wall of the wellbore. In some embodiments, the well bore is contacted with the chemical-scale inhibitor for at least 1 hour (h), preferably at least 2 h, preferably at least 3 h, preferably at least 4 h, preferably at least 5 h, preferably at least 6 h, preferably at least 7 h, preferably at least 8 h, preferably at least 9 h, preferably at least 10 h, preferably at least 11 h, preferably at least 12 h, preferably at least 13 h, preferably at least 14 h, preferably at least 15 h, preferably at least 16 h, preferably at least 17 h, preferably at least 18 h, preferably at least 19 h, preferably at least 20 h, preferably at least 21 h, preferably at least 22 h, preferably at least 23 h, most preferably at least 24 h. In another embodiment, the well bore is contacted with the chemical-scale inhibitor for at least 1 day, preferably at least 1.5 days, preferably at least 2 days, preferably at least 2.5 days, preferably at least 3 days, preferably at least 3.5 days, preferably at least 4 days, preferably at least 4.5 days, preferably at least 5 days, preferably at least 5.5 days, preferably at least 6 days, preferably at least 6.5 days, most preferably at least 7 days.

In some embodiments, the onset of sulfate-comprising scale formation is delayed by at least 24 h. In another embodiment, the onset of the sulfate-comprising scale formation is delayed by at least 1.5 days, preferably at least 2 days, preferably at least 2.5 days, preferably at least 3 days, preferably at least 3.5 days, preferably at least 4 days, preferably at least 4.5 days, preferably at least 5 days, preferably at least 5.5 days, preferably at least 6 days, preferably at least 6.5 days, most preferably at least 7 days.

In some embodiments, the wall of the wellbore contacted with the chemical scale inhibitor is at a temperature of 150 to 320° F. In another embodiment, the wall of the wellbore contacted with the chemical scale inhibitor is at a temperature of 152 to 318° F., preferably 154 to 316° F., preferably 156 to 314° F., preferably 158 to 312° F., preferably 160 to 310° F., preferably 162 to 308° F., preferably 164 to 306° F., preferably 166 to 304° F., preferably 168 to 302° F., preferably 170 to 300° F., preferably 172 to 298° F., preferably 174 to 296° F., preferably 176 to 294° F., preferably 178 to 292° F., preferably 180 to 290° F., preferably 182 to 288° F., preferably 184 to 286° F., preferably 186 to 284° F., preferably 188 to 282° F., preferably 190 to 280° F., preferably 192 to 278° F., preferably 194 to 276° F., preferably 196 to 274° F., preferably 198 to 272° F., preferably 200 to 270° F., preferably 202 to 268° F., preferably 204 to 266° F., preferably 206 to 264° F., preferably 208 to 262° F., preferably 210 to 260° F., preferably 212 to 258° F., preferably 214 to 256° F., preferably 216 to 254° F., preferably 218 to 252° F., preferably 220 to 250° F., preferably 222 to 248° F., preferably 224 to 246° F., preferably 226 to 244° F., preferably 228 to 242° F., preferably 230 to 240° F., preferably 232 to 238° F., preferably 234 to 236° F. In a specific embodiment, the wall of the wellbore contacted with the chemical scale inhibitor is at a temperature of 150° F. In another specific embodiment, the wall of the wellbore contacted with the chemical scale inhibitor is at a temperature of 320° F.

In some embodiments, the chemical scale inhibitor has a pH of 6 to 9 at an initiation of the contacting. In another embodiment, the chemical scale inhibitor has a pH of 6.2 to 8.8 at an initiation of the contacting, preferably 6.4 to 8.6, preferably 6.6 to 8.4, preferably 6.6 to 8.2, preferably 6.6 to 8.4, preferably 6.6 to 8, preferably 6.6 to 7.8, preferably 6.6 to 7.6, preferably 6.6 to 7.4, preferably 6.6 to 7.2, preferably 6.6 to 7, preferably 6.6 to 6.8. In a preferred embodiment, the chemical scale inhibitor has a pH of 6.67 at an initiation of the contacting. In some embodiments, the chemical scale inhibitor has a pH of 1 to 6 at a termination of the contacting. In another embodiment, the chemical scale inhibitor has a pH of 1.2 to 6 at a termination of the contacting, preferably 1.4 to 6, preferably 1.6 to 6, preferably 1.8 to 6, preferably 2 to 6, preferably 2.2 to 6, preferably 2.4 to 6, preferably 2.6 to 6, preferably 2.8 to 6, preferably 3 to 6, preferably 3.2 to 6, preferably 3.4 to 6, preferably 3.6 to 6, preferably 3.8 to 6, preferably 4 to 6, preferably 4.2 to 6, preferably 4.4 to 6, preferably 4.6 to 6, preferably 4.8 to 6, preferably 5 to 6, preferably 5.2 to 6, preferably 5.4 to 6, preferably 5.6 to 6, most preferably 5.8 to 6. In a preferred embodiment, the chemical scale inhibitor has a pH of 5.95 at a termination of the contacting.

In some embodiments, the sulfate-comprising scale comprises at least one selected from the group consisting of barium sulfate, strontium sulfate, magnesium sulfate, sodium sulfate, ammonium sulfate, iron sulfate, lead sulfate, copper sulfate, zinc sulfate, cadmium sulfate, manganese sulfate, nickel sulfate, silver sulfate, thallium sulfate, cobalt sulfate, potassium sulfate, aluminum sulfate, lithium sulfate, cesium sulfate, rubidium sulfate, yttrium sulfate, thorium sulfate, uranium sulfate, chromium sulfate, molybdenum sulfate, tungsten sulfate, zirconium sulfate, hafnium sulfate, gallium sulfate, germanium sulfate, and indium sulfate. In another embodiment, the sulfate-comprising scale comprises at least one selected from the group consisting of calcium sulfate, magnesium sulfate, iron sulfate, and barium sulfate. In a specific embodiment, the sulfate-comprising scale comprises barium sulfate. In another specific embodiment, the sulfate-comprising scale comprises calcium sulfate.

In some embodiments, at a temperature of 150 to 320° F., no sulfate-comprising scale precipitate forms in an aqueous composition comprising 0.35 to 1 w/v % of 1-butyl-2,3-dimethylimidazolium hexafluorophosphate and 0.1 to 0.5 g/L NaHCO₃, 0.5 to 6 g/L Na₂SO₄, 40 to 155 g/L NaCl, 2 to 70 g/L CaCl₂·2H₂O, and 17 to 20 g/L MgCl₂·6H₂O. In another embodiment, at a temperature of 150 to 320° F., no sulfate-comprising scale precipitate forms in an aqueous composition comprising 0.36 to 1 w/v % of 1-butyl-2,3-dimethylimidazolium hexafluorophosphate, preferably 0.38 to 1 w/v %, preferably 0.40 to 1 w/v %, preferably 0.42 to 1 w/v %, preferably 0.44 to 1 w/v %, preferably 0.46 to 1 w/v %, preferably 0.48 to 1 w/v %, preferably 0.50 to 1 w/v %, preferably 0.52 to 1 w/v %, preferably 0.54 to 1 w/v %, preferably 0.56 to 1 w/v %, preferably 0.58 to 1 w/v %, preferably 0.60 to 1 w/v %, preferably 0.62 to 1 w/v %, preferably 0.64 to 1 w/v %, preferably 0.66 to 1 w/v %, preferably 0.68 to 1 w/v %, preferably 0.70 to 1 w/v %, preferably 0.72 to 1 w/v %, preferably 0.74 to 1 w/v %, preferably 0.76 to 1 w/v %, preferably 0.78 to 1 w/v %, preferably 0.80 to 1 w/v %, preferably 0.82 to 1 w/v %, preferably 0.84 to 1 w/v %, preferably 0.86 to 1 w/v %, preferably 0.88 to 1 w/v %, preferably 0.90 to 1 w/v %, preferably 0.92 to 1 w/v %, preferably 0.94 to 1 w/v %, preferably 0.96 to 1 w/v %, preferably 0.98 to 1 w/v %, most preferably 1 w/v % 1-butyl-2,3-dimethylimidazolium hexafluorophosphate and 0.1 to 0.5 g/L NaHCO₃, 0.5 to 6 g/L Na₂SO₄, 40 to 155 g/L NaCl, 2 to 70 g/L CaCl₂·2H₂O, and 17 to 20 g/L MgCl₂·6H₂O.

In some embodiments, at a temperature of 150° F., no sulfate-comprising scale precipitate forms in an aqueous composition comprising 0.35 to 1 w/v % of 1-butyl-2,3-dimethylimidazolium hexafluorophosphate and 0.1 to 0.5 g/L NaHCO₃, 0.5 to 6 g/L Na₂SO₄, 40 to 155 g/L NaCl, 2 to 70 g/L CaCl₂·2H₂O, and 17 to 20 g/L MgCl₂·6H₂O. In another embodiment, at a temperature of 150° F., no sulfate-comprising scale precipitate forms in an aqueous composition comprising 0.36 to 1 w/v % of 1-butyl-2,3-dimethylimidazolium hexafluorophosphate, preferably 0.38 to 1 w/v %, preferably 0.40 to 1 w/v %, preferably 0.42 to 1 w/v %, preferably 0.44 to 1 w/v %, preferably 0.46 to 1 w/v %, preferably 0.48 to 1 w/v %, preferably 0.50 to 1 w/v %, preferably 0.52 to 1 w/v %, preferably 0.54 to 1 w/v %, preferably 0.56 to 1 w/v %, preferably 0.58 to 1 w/v %, preferably 0.60 to 1 w/v %, preferably 0.62 to 1 w/v %, preferably 0.64 to 1 w/v %, preferably 0.66 to 1 w/v %, preferably 0.68 to 1 w/v %, preferably 0.70 to 1 w/v %, preferably 0.72 to 1 w/v %, preferably 0.74 to 1 w/v %, preferably 0.76 to 1 w/v %, preferably 0.78 to 1 w/v %, preferably 0.80 to 1 w/v %, preferably 0.82 to 1 w/v %, preferably 0.84 to 1 w/v %, preferably 0.86 to 1 w/v %, preferably 0.88 to 1 w/v %, preferably 0.90 to 1 w/v %, preferably 0.92 to 1 w/v %, preferably 0.94 to 1 w/v %, preferably 0.96 to 1 w/v %, preferably 0.98 to 1 w/v %, most preferably 1 w/v % 1-butyl-2,3-dimethylimidazolium hexafluorophosphate and 0.1 to 0.5 g/L NaHCO₃, 0.5 to 6 g/L Na₂SO₄, 40 to 155 g/L NaCl, 2 to 70 g/L CaCl₂·2H₂O, and 17 to 20 g/L MgCl₂·6H₂O.

In some embodiments, at a temperature of 320° F., no sulfate-comprising scale precipitate forms in an aqueous composition comprising 0.30 to 0.90 w/v % of 1-butyl-2,3-dimethylimidazolium hexafluorophosphate and 0.1 to 0.5 g/L NaHCO₃, 0.5 to 6 g/L Na₂SO₄, 40 to 155 g/L NaCl, 2 to 70 g/L CaCl₂·2H₂O, and 17 to 20 g/L MgCl₂·6H₂O. In another embodiment, at a temperature of 320° F., no sulfate-comprising scale precipitate forms in an aqueous composition comprising 0.32 to 0.98 w/v % of 1-butyl-2,3-dimethylimidazolium hexafluorophosphate, preferably 0.34 to 0.96 w/v %, preferably 0.36 to 0.94 w/v %, preferably 0.38 to 0.92 w/v %, preferably 0.40 to 0.90 w/v %, preferably 0.42 to 0.88 w/v %, preferably 0.44 to 0.86 w/v %, preferably 0.46 to 0.84 w/v %, preferably 0.48 to 0.82 w/v %, preferably 0.50 to 0.80 w/v %, preferably 0.50 to 0.78 w/v %, preferably 0.50 to 0.76 w/v %, most preferably 0.50 to 0.75 w/v % 1-butyl-2,3-dimethylimidazolium hexafluorophosphate and 0.1 to 0.5 g/L NaHCO₃, 0.5 to 6 g/L Na₂SO₄, 40 to 155 g/L NaCl, 2 to 70 g/L CaCl₂·2H₂O, and 17 to 20 g/L MgCl₂·6H₂O.

### EXAMPLES

The following examples demonstrate a method of scale inhibition as described herein. The examples are provided solely for illustration and are not to be construed as limitations of the present disclosure, as many variations thereof are possible without departing from the spirit and scope of the present disclosure.

### Example 1: Materials

In the present disclosure, 1-butyl-2,3-dimethylimidazolium hexafluorophosphate (1B3DM6FP) was used as a scale inhibitor, for high-temperature and high pressure oil wellbores. The 1B3DM6FP was obtained from Sigma-Aldrich. Further, properties of the 1B3DM6FP are listed in Table 1.

TABLE 1
Properties of 1B3DM6FP

| | CAS | | Molecular | Structure |
|---|---|---|---|---|
| Name | number | Density | weight | |
| 1-Butyl-2,3- dimethyl- imidazolium hexafluoro- phosphate | 227617- 70-1 | 1,345 g/mL at 20° C. | 298.21 g/mol | 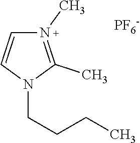 |

The composition of the sea water (SW) and formation water (FW) are listed in Table 2. The total dissolved solids in SW and FW are 67707 parts per million (ppm) and 241688 ppm, respectively.

TABLE 2
Salt composition of SW and FW

| Salts | Sea Water (g/Liter) | Formation Water (g/Liter) |
|---|---|---|
| NaHCO₃ | 0.165 | 0.487 |
| Na₂SO₄ | 6.339 | 0.518 |
| NaCl | 41.172 | 150.446 |
| CaCl₂•2H₂O | 2.387 | 69.841 |
| MgCl₂•6H₂O | 17.644 | 20.396 |

### Example 2: Prevention of Scale Formation with 1B3DM6FP at 150° F.

Both synthetic brines were mixed in a 50:50 ratio to generate scale and the 1B3DM6FP was added in different percentages to find the desirable outcomes. Table 3 lists the static bottle evaluation results of 1B3DM6FP as a scale inhibitor, conducted in a SW and FW mixture at a temperature of 150° F. The range of concentrations evaluated was from about 0.15% to 1%.

TABLE 3
Scale testing at 150° F. with different concentrations of 1B3DM6FP

| | | Initial | | | | | | | | Final |
|---|---|---|---|---|---|---|---|---|---|---|
| IL | Conc. | pH | Day 1 | Day 2 | Day 3 | Day 4 | Day 5 | Day 6 | Day 7 | pH |
| 1B3DM6FP | 1% | 6.67 | Blank | Blank | Blank | Blank | Blank | Blank | Blank | 5.95 |
| 1B3DM6FP | 0.90% | 6.64 | Cloudy | Cloudy | Cloudy | Cloudy | Cloudy | Cloudy | Cloudy | 5.9 |
| 1B3DM6FP | 0.75% | 6.62 | Blank | Cloudy | Cloudy | Cloudy | Scale | Scale | Scale | 5.81 |
| 1B3DM6FP | 0.50% | 6.59 | Blank | Blank | Blank | Cloudy | Scale | Scale | Scale | 5.62 |
| 1B3DM6FP | 0.38% | 6.3 | Blank | Blank | Cloudy | Scale | Scale | Scale | Scale | 5.51 |
| 1B3DM6FP | 0.15% | 6.2 | Scale | Scale | Scale | Scale | Scale | Scale | Scale | |
| Base | 0% | | Scale | Scale | Scale | Scale | Scale | Scale | Scale | |

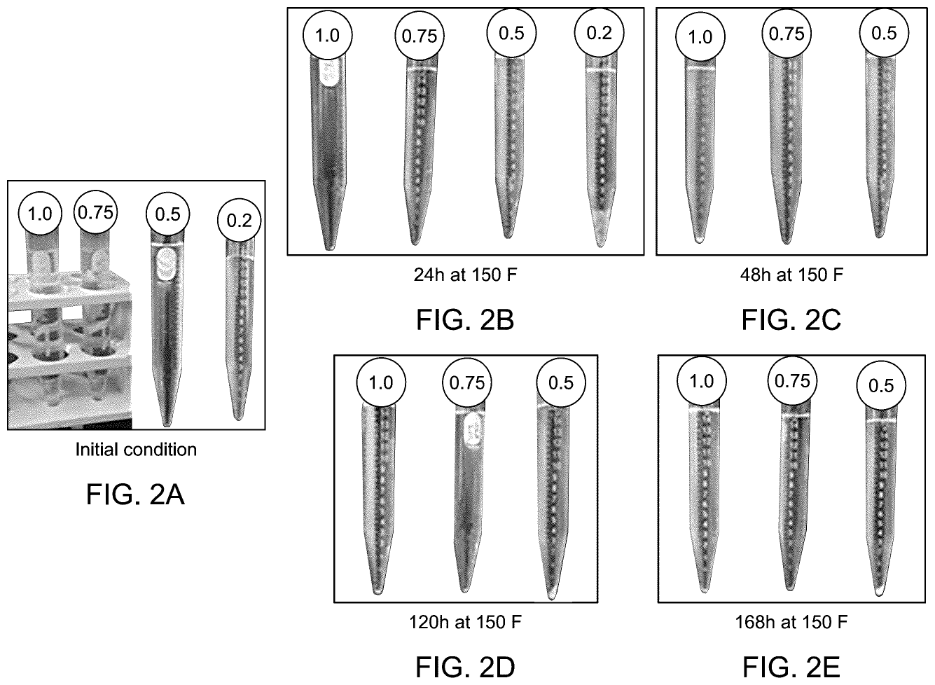

Referring to FIGS. 2A through 2E, optical images of a plurality of test tube including the SW and FW with different concentrations of 1B3DM6FP are depicted, according to certain embodiments. The test tubes were kept at 150° F. for varying time intervals, in order to assess the scale inhibition performance of the 1B3DM6FP. In particular, the FIGS. 2A through 2E depict the initial condition of the test tubes and their state at various intervals including 24 hours, 48 hours, 120 hours, and 168 hours. As can be seen from FIGS. 2A through 2E, the test tubes are labeled with different concentration values including 1.0, 0.75, 0.5, and 0.2, indicating the concentration of the scale inhibitor in each test tube. The progression of time and temperature exposure shows changes in the clarity of the solutions, indicating the efficacy of the scale inhibitor at different concentrations over time with the cloudiness of a solution indicating the potential beginnings of scale formation.

### Example 3: Prevention of Scale Formation with 1B3DM6FP at 320° F.

The scale inhibition performance of 1B3DM6FP was further evaluated in a very high-temperature environment at about 320° F. Table 4 lists the test tube results for two different concentrations. Both concentrations maintained a “cloudy” appearance consistently over seven days, suggesting some level of interaction with scale formation. Furthermore, there was no sign of scale crystals in test tubes, illustrating the efficacy of 1B3DM6FP as a scale inhibitor.

Numerous modifications and variations of the present disclosure are possible in light of the above teachings. It is therefore to be understood that within the scope of the appended claims, the invention may be practiced otherwise than as specifically described herein.

1. A method of inhibiting sulfate-comprising scale formation in a high-pressure high-temperature (HPHT) wellbore, comprising:
injecting a chemical scale inhibitor into a wellbore disposed in a subterranean geological formation to form a chemical scale inhibitor composition in the wellbore;
contacting the chemical scale inhibitor composition with a wall of the wellbore to delay an onset of sulfate-comprising scale formation on the wall of the wellbore,
wherein the chemical scale inhibitor is 1-butyl-2,3-dimethylimidazolium hexafluorophosphate and the chemical scale inhibitor composition comprises from 0.15 w/v % to 1.0 w/v % of the 1-butyl-2,3-dimethylimidazolium hexafluorophosphate, and
wherein the onset of sulfate-comprising scale formation is delayed by at least 24 h, and
wherein the wall of the wellbore contacted with the chemical scale inhibitor composition is at a temperature of at least 150° F.

2. The method of claim 1, wherein the sulfate-comprising scale comprises at least one selected from the group consisting of calcium sulfate, magnesium sulfate, iron sulfate, and barium sulfate, and
wherein the chemical scale inhibitor is injected into the wellbore as a mixture with water and particles of a synthetic wax having a melting point of at least 130° C.

3. The method of claim 1, wherein the chemical scale inhibitor composition comprises 0.5 w/v % to 1.0 w/v % of the 1-butyl-2,3-dimethylimidazolium hexafluorophosphate.

4. The method of claim 1, wherein no sulfate-comprising scale precipitate is formed in an aqueous composition comprising 0.1 to 0.5 g/L NaHCO₃, 0.5 to 6 g/L Na₂SO₄, 40 to 150 g/L NaCl, 2 to 70 g/L CaCl₂·2H₂O, 17 to 20 g/L MgCl₂·6H₂O, and 0.35 to 1 w/v % of the 1-butyl-2,3-dimethylimidazolium hexafluorophosphate at a temperature of from 150 to 320° F.

5. The method of claim 1, wherein the contacting is performed for at least 1 hour under static well pressure.

6. The method of claim 1, wherein the pH of the chemical scale inhibitor composition is from 6 to 9 at an initiation of the contacting.

7. The method of claim 1, wherein the sulfate-comprising scale comprises barium sulfate.

8. The method of claim 1, wherein the chemical scale inhibitor is an aqueous solution comprising at least 0.35 w/v % of the 1-butyl-2,3-dimethylimidazolium hexafluorophosphate.

9. The method of claim 1, wherein the pH of the chemical scale inhibitor composition is from 1 to 6 at a termination of the contacting.

10. The method of claim 1, wherein the chemical scale inhibitor prevents formation of a sulfate-comprising scale precipitate in an aqueous composition comprising 0.1 to 0.5 g/L NaHCO₃, 0.5 to 6 g/L Na₂SO₄, 40 to 151 g/L NaCl, 2 to 70 g/L CaCl₂·2H₂O, 17 to 21 g/L MgCl₂·6H₂O, and 0.9 to 1 w/v % of the 1-butyl-2,3-dimethylimidazolium hexafluorophosphate at a temperature of 150° F.

11. The method of claim 1, wherein the chemical scale inhibitor composition further comprises at least one additive selected from the group consisting of a an ammonium salt, a cross-linking agent, a proppant, an oxygen scavenger, a corrosion inhibitor, a fluid-loss additive, a friction reducer, a chelating agent, a dispersant, a wetting agent, a scale disperser, a pH stabilizer, a de-emulsifier, a hydrate inhibitor, a clay stabilizer, an anti-foaming agent, a viscosifier, a fluid stabilizer, a thermal stabilizer, a flow enhancer, a scale dissolver, a fouling inhibitor, a defoamer, a crystallization inhibitor, and a scale modifier.

12. The method of claim 1, wherein the wall of the wellbore contacted with the chemical scale inhibitor composition is at a temperature of 150 to 320° F.

13. The method of claim 1, wherein the sulfate-comprising scale comprises calcium sulfate.

14. The method of claim 1, wherein the contacting is performed for at least 24 hours.

15. The method of claim 1, wherein the chemical scale inhibitor composition further comprises seawater comprising 0.1 to 0.2 g/L NaHCO₃, 6 to 7 g/L Na₂SO₄, 41 to 42 g/L NaCl, 2 to 3 g/L CaCl₂·2H₂O, and 17 to 18 g/L MgCl₂·6H₂O, and/or
formation water comprising 0.4 to 0.5 g/L NaHCO₃, 0.5 to 0.6 g/L Na₂SO₄, 150 to 151 g/L NaCl, 69 to 70 g/L CaCl₂·2H₂O, and 20 to 21 g/L MgCl₂·6H₂O.

16. The method of claim 1, wherein the chemical scale inhibitor further comprises a brine comprising a synthetic seawater and a formation water, and
wherein the brine has a weight ratio of the synthetic seawater to the formation water of 1:3 to 3:1.

17. The method of claim 1, wherein the chemical scale inhibitor has a density of 1.10 to 1.50 g/cm³ at a temperature of 20° C.

18. The method of claim 1, wherein the chemical scale inhibitor has a viscosity of 10 to 100 cP.

19. The method of claim 1, wherein no sulfate-comprising scale precipitate is formed in an aqueous composition comprising 0.1 to 0.5 g/L NaHCO₃, 0.5 to 6 g/L Na₂SO₄, 40 to 151 g/L NaCl, 2 to 70 g/L CaCl₂·2H₂O, 17 to 21 g/L MgCl₂·6H₂O, and 0.5 to 0.75 w/v % of 1-butyl-2,3-dimethylimidazolium hexafluorophosphate at a temperature of 320° F.

20. The method of claim 1, wherein the chemical scale inhibitor has a density of 1.30 to 1.50 g/cm³ at a temperature of 20° C.
